(19) United States
(12) Patent Application Publication
(10) Pub. No.: US 2009/0144007 A1
(43) Pub. Date: Jun. 4, 2009

(54) System and method for electronic testing of devices

(76) Inventors: Jose MOREIRA, (US); Ajay KHOCHE, San Jose, CA (US); Erik VOLKERINK, Palo Alto, CA (US)

Correspondence Address: Gregory W. Osterloth;Holland & Hart, LLP, P.O. Box 8749, Denver, CO, 80201, US

(21) Appl. No.: 11/998,616

(22) Filed: Nov. 29, 2007

(51) Int. Cl. G06F 19/00

(52) U.S. Cl. 702/81

(57) ABSTRACT

A system and method electronically tests devices. The method comprises receiving a first testing model including a first plurality of parameters and acceptable limits for the first plurality of parameters; receiving a second testing model including a second plurality of parameters and acceptable limits for the second plurality of parameters; receiving a first value for a first parameter from the first plurality of parameters, the first parameter at least partially affecting a second parameter from the second plurality of parameters; determining a second value for the second parameter based on the first value; determining if the first value is within the acceptable limits for the first parameter; determining if the second value is within the acceptable limits for the second parameter; and providing an indication when at least one of the first and second values is outside the acceptable limits for a corresponding one of the first and second parameters.

### BACKGROUND

A newly manufactured electronic device is tested to create stimulus signals and capture responses. These measurements may be used to, for example, measure actual performance against expected performance. The expected performance may be performance metrics defined by a manufacturer, an industry standard, etc. For example, an electronic device which purports to be compliant with the Peripheral Component Interconnect-Express (PCI-Express) specification must meet the performance metrics defined therein. The proper operation of the electronic devices may then be proven or faults in the devices may be traced and repaired. For example, memory modules including a plurality of memory devices are tested to ensure capabilities prior to introduction into markets.

Conventionally, the newly manufactured electronic device is tested upon completion of manufacture. That is, the electronic device is subject to performance measurements after a final product is produced. The performance measurements may consist of various parametric measurements pertaining to different aspects of the electronic device. The parametric measurements are compared to corresponding values that are expected of the electronic device. The primary concern of testing a final product is determining whether the device performs as expected or is compliant to a standard. That is, only a pass or fail response is sought.

The time taken to test an electronic device is directly proportional to the final cost of the electronic device. Consequently, manufacturers decide to use a sub-set of measurements that would guarantee that the device works as intended and would also guarantee compliance with some standard. The sub-set of measurements may be correlated to represent the full set of measurements required by the standard. The sub-set of measurements may also contain new measurements that are not required by the standard but provide more test information than standard compliant measurements. This correlation is typically a lengthy process that is done only once and generates a significant amount of data.

During the production of the device, changes on the production process (e.g., errors due to a lithography mask misalignment, a change in environmental conditions, etc.) may have an effect on the device performance. The manufacturer may observe this effect by a change on the measured values on the device test. The device manufacturer must then determine which factor in the manufacturing process is responsible for the change. The device manufacturer must also determine which of the final test values of the reduced measurement set correspond to compliance with the standards the device is intended.

To address this challenge, there is a need to design a more efficient method that uses the measurement data gathered during the production ramp and normal production. There is also a need to remove the barrier between the physical manufacturing process and the cost effective reduced measurement set for final testing used for compliance with industry standards. Thus, when a process change occurs or a new value is required by the standard, the device manufacturer is able to evaluate any effect on all relevant and important perspectives.

### SUMMARY OF THE INVENTION

The present invention relates to a system and method for electronic testing of devices. The method comprises receiving a first testing model including a first plurality of parameters and acceptable limits for the first plurality of parameters; receiving a second testing model including a second plurality of parameters and acceptable limits for the second plurality of parameters; receiving a first value for a first parameter from the first plurality of parameters, the first parameter at least partially affecting a second parameter from the second plurality of parameters; determining a second value for the second parameter based on the first value; determining if the first value is within the acceptable limits for the first parameter; determining if the second value is within the acceptable limits for the second parameter; and providing an indication when at least one of the first and second values is outside the acceptable limits for a corresponding one of the first and second parameters.

### DESCRIPTION OF THE DRAWINGS

FIG. 1 shows an exemplary embodiment of a system according to the present invention.

FIG. 2 shows an exemplary embodiment of a testing architecture according to the present invention.

FIG. 3 shows an exemplary embodiment of a method according to the present invention.

### DETAILED DESCRIPTION

The present invention may be further understood with reference to the following description and the appended drawings, wherein like elements are referred to with the same reference numerals. The exemplary embodiments of the present invention provide a system and method for performing an electronic test on an electronic device. The exemplary embodiments of the present invention will be described with reference to the electronic test producing parametric measurements that are used as a basis for comparison with a production model, a device model, and/or a standard model. The electronic test and the models will be described in detail below. It should be noted that multiple standard models may exist for every type of electronic device such as PCI-Express, Serial ATA, Fiber Channel, Gigabit Ethernet, etc. for testing various parameters of the electronic device. The following exemplary embodiments describe a testing device that measures parametric performance for a single electronic device. However, those skilled in the art will understand that the present invention may also apply to testing devices that are capable of measuring parametric performances for multiple electronic devices concurrently.

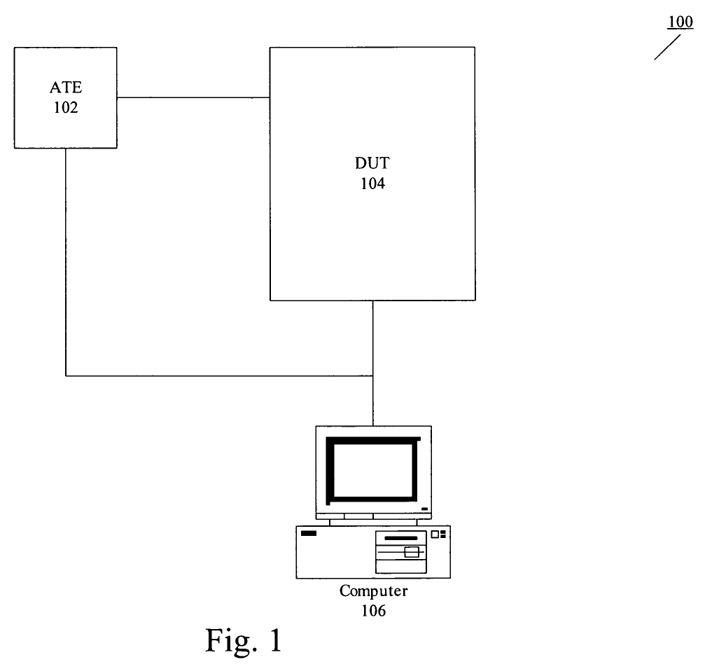

FIG. 1 shows an exemplary embodiment of a system 100 according to the present invention. The system 100 may be for performing a test on an electronic device. The test may be for various types of electronic devices (e.g., a DRAM device, a graphics processor, etc.) and may, therefore, include the various tests performed for the specific type of electronic device. For example, with a graphics processor device, a jitter generation test may be performed to determine if the graphics device is compliant with jitter generation requirements defined in the PCI-Express standard that standardizes the communication requirements between a graphics chip and the microprocessor in a computer. Compliance with standard specification is important since it guarantees interoperability between different devices designed and manufactured by different companies. The exemplary embodiments of the present invention incorporate the various tests required for testing the various types of electronic devices.

The system 100 includes an automatic test equipment (ATE) device 102 which is electrically coupled to a device under test (DUT) 104. The system 100 may further include a computer 106 (e.g., PC, laptop, tablet, etc.) which is coupled to the DUT 104 and/or the ATE device 102. The computer 106 (or any of the DUT 104 and the ATE device 102) may include a memory storing a set of instructions for implementing the electronic test. The computer 106 may include an output device, e.g., display screen, printer, etc., for outputting results of the electronic test. It should be noted that multiple ATE devices may be electrically coupled to the DUT 104 and further to the computer 106. For example, with frequency offset tests, one ATE device may include transmit and receive lines for data transmission/reception. Another ATE device may include a clock to time the different data transfers.

In the exemplary embodiment, the DUT 104 may be an electronic device (e.g., a graphics processor chip, a microprocessor, a video card, a high speed memory device, etc.) which purports to operate in accordance with a test procedure such as a manufacturer specification, a production specification, the PCI-Express specification, IEEE specification, etc. Thus, the DUT 104 may be any device in a consumer electronic or high-end engineering application, such as satellite, data processing, telecommunications, etc. The DUT 104 may implement, for example, a System-on-a-Chip (SoC) or a System-in-a-Package (SIP) architecture. The ATE device 102 may be SoCs which include a microprocessor, memory and a plurality of application specific integrated circuits (ASICs) implementing a test-per-pin architecture in which each pin of the DUT 104 may be tested independently. For example, the ATE device 102 may be for digital testing channels. The ATE 102 measures parametric performance measurements pertaining to the DUT 104. This data may be transmitted to the computer 106 for storage and/or processing. Those skilled in the art will understand that the testing system 100 is only exemplary and that the present invention may be implemented on any type of testing system or arrangement.

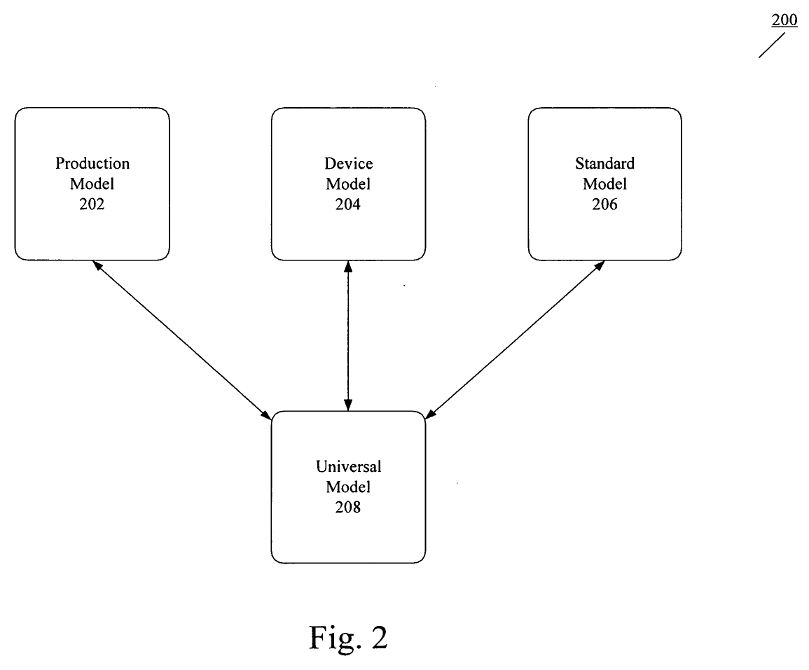

FIG. 2 shows an exemplary embodiment of a testing architecture 200 according to the present invention. The testing architecture 200 includes a production model (PM) 202, a device model (DM) 204, a standard model (SM) 206, and a universal model (UM) 208. It should be noted that the use of these models is only exemplary and the testing architecture 200 may include fewer or more models depending on the preference of the manufacturer and the testing requirements for the DUT 104. For example, if industry standards are the only limiting factor to be considered, the testing architecture may include the PM 202 and the SM 206, with no DM 204. The different models and their relationships will be discussed in detail below. The testing architecture 200 will be described with reference to the system 100 of FIG. 1.

The PM 202 may represent a model of the device from the manufacturing process perspective. This may be, for example, a model that describes the influence of changes of the manufacturing process (e.g. dopant concentration on a given semiconductor manufacturing step) on an individual transistor performance which may than be augmented to a model of the device by modeling each transistor on the device using the single transistor model. Typically, only critical parts of the device such as the I/O cell would be modeled. The models may also include a statistical model representing the inherent statistical behavior of semiconductor manufacturing, especially at nanometer sizes. The model may also include, for example, physical models of the metal interconnections between the individual transistors as specified on the device layout with the model linked to the specifics of the manufacturing process (e.g., process parameters of the etching process step that creates the metal lines for one layer). The output value of the model may include process variables measured during production (e.g., temperature measured on the diffusion chamber) and also the set of measurements done during final testing which may be a reduced set for fast test times or an augmented set of final test measurements used during production ramp and correlation. It should be noted that this model may be constructed using available semiconductor physical models published in scientific literature and subsequently tuned and improved based on production data.

The DM 204 may represent a model of the device that is linked to a behavior of the device as intended by the function that the device is intended to perform by its design. That is, the DM 204 may a higher level model than the PM 202. The DM 204 may be, for example, a model done in a programming language, an electronic circuit simulating software, a general purpose simulation software, etc. In the PM 202, a phase lock loop (PLL) may be represented by a detailed physical model of the PLL implementation. However, in the DM 204, the PLL may be represented by a single equation representing the behavior of the PLL as expected by the designer. The output of the DM 204 may be linked very tightly to the final test measurements. Furthermore, with a production ramp, an augmented measured set used in the initial production ramp may use the output values of the DM 204.

The SM 206 may represent a model of the device behavior in regards to an industry standard. For example, an industry standard for inter-device communication such as PCI-Express specifies the minimal electrical requirements in which a device must comply in order to communicate without problems with other PCI-Express compliant devices. Those skilled in the art will understand that industry standards typically do not specify the method of implementation of the requirements. That is, the SM 206 may be a higher model than the DM 204 or the PM 202 in which the methodology of implementation of the requirements or its physical manufacturing is irrelevant. However, a basic model for standard compliance (e.g., a list of minimum electrical specifications) may need to be augmented to link the measurements taken on a final testing or even the larger set of measurements typically used in the production ramp. This may be due to the existence of values required by the standard that are not directly observable from the final test measurements. For example, the random and deterministic jitter values defined may be some standard such as PCI-Express. The values may not be directly measurable with a given final production measurement setup. That is, the use of another measurement (e.g., BER bathtub curve) may be required to obtain the measurement setup. Consequently, the measurements may be coupled with a model of the output jitter of the device, thereby the random and deterministic jitter values may be computed.

The UM 208 may represent a model that is intended to link the PM 202, the DM 104, and the SM 206 models, thereby creating a communication path between the different models. Due to complexity, the UM 208 may be a model with no pre-assumptions (e.g., Neural Network) that uses all available variables of the PM 202, the DM 204, and/or the SM 206 to develop a mapping between the models and also to use global information to compute overall variables that may be of interest to the device manufacturer. For example, the UM 208 may indicate how a change in the production process variable in the PM 202 would affect compliance with a standard specification as defined in the SM 206, thereby indicating a potential non-compliance issue with a model. The UM 208 may also provide additional values of interest for management of the device such as a life-cycle, an expected production yield, a safety margin in a specific standard specification, etc.

The PM 202, the DM 204, and the SM 206 may exchange data with the UM 208. It should be noted that other testing architectures may provide a data exchange between the PM 202, the DM 204, and/or the SM 206. The UM 208 may be an independent model (e.g., a neural network) that provides correlative data relating to the DUT 104. That is, the parametric performance measurements of the DUT 104 found using the system 100 of FIG. 1 may be compared to the data included in the models. As discussed above, the PM 202 may use different measurement values than either the DM 204 or the SM 206. It should be noted that the PM 202, the DM 204, and the SM 206 may be defined in a variety of ways if the device is working as desired from the model perspective. However, the UM 208 would link all the models and provide a measure of the production yield and which parameters are responsible for a possible yield loss.

The correlative data provided by the UM 208 may be used for various purposes. In one exemplary embodiment of the present invention, the correlative data may be used to determine whether changes to the DUT 104 are necessary. For example, if the UM 208 is configured so that no changes may be made to the SM 206, the specification set out in the SM 206 are used. The standard specifications may provide minimum requirements for electronic devices. Thus, when the correlative data determines that the DUT 104 performs below the specification of the SM 206, changes may be necessary for the DUT 104.

In another exemplary embodiment of the present invention, the correlative data may be used to determine whether changes to the DM 204 are necessary. For example, if the DUT 104 is configured with the maximum functional capabilities (i.e., no further improvements are possible) and the specification of the DM 204 are used, when the DUT 104 performs below the DM 204, then changes may be necessary to the DM 204. It should be noted that changing the DM 204 in this embodiment is only exemplary and the DM 204 may be maintained. That is, if the specification of the DM 204 is a target performance measurement for the electronic device to operate, then changes to the DUT 104 may be made to attempt to reach those operating parameters.

It should be noted that the PM 202, the DM 204, the SM 206, and the UM 208 may be stored on a memory of the computer 106 and/or embodied as software programmed to be executed by a processor of the computer 106. In another embodiment, the models may each be on a separate computer or a combination thereof.

Thus, as will be described in more detail below, as the system 100 is collecting parameter data based on one of the models (e.g., the PM 202), this data may be sent to the UM 208 to determine how this data impacts the other testing models (e.g., DM 204, SM 206). This may allow for pre-emptive changes to the device and/or the testing of the device. It is typical that each of the testing models is defined by different groups (e.g., the PM 202 by the manufacturing group, the DM 204 by the design group and the SM 206 by an independent standards group). The UM 208 provides for a simple manner of determining the interrelationship among the various testing models. For example, during testing based on the PM 202, an exemplary parameter A may be measured and this parameter may pass the PM 202. However, when this measured parameter A data is sent to the UM 208, it may be determined that parameter A is also measured or affect some parameter in the DM 204. The UM 208 may determine that the measured parameter A also passes the constraints or has no significant effect (e.g., is compliant) on the DM 204 and therefore no changes need to be made. However, the UM 208 may determine that the measured parameter A does not pass the constraints or has a significant effect (e.g., creates a non-compliance) on the DM 204. The UM 208 may signal this failure and then a decision may be made to alter the DUT 104 and/or the DM 204.

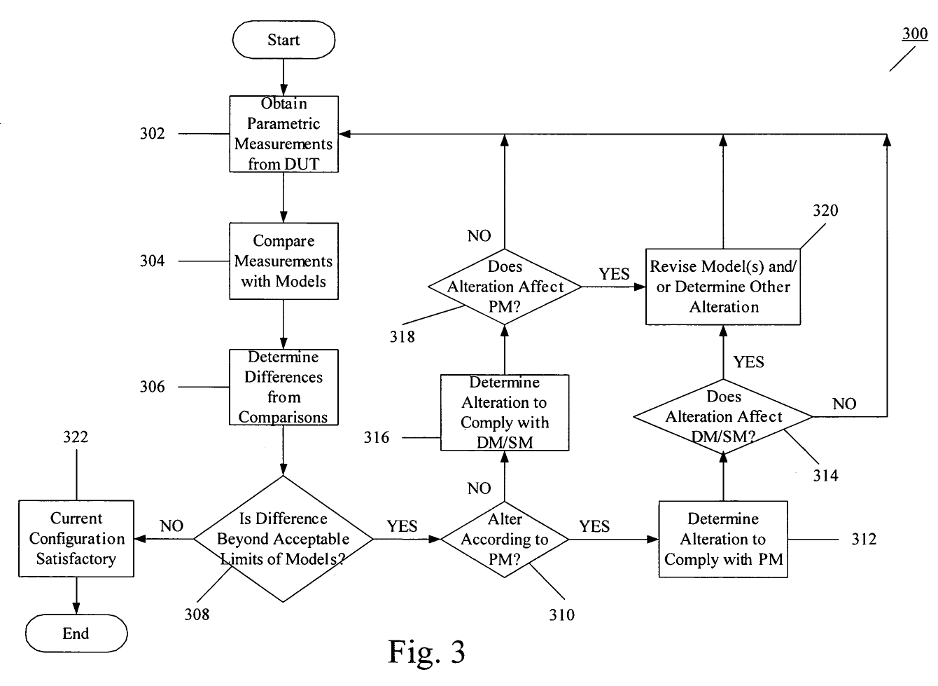

FIG. 3 shows an exemplary embodiment of a method 300 according to the present invention. The method 300 utilizes different specification models to optimize the manufacture of an electronic device. The method 300 also provides an efficient process by concurrently determining compliance with specification models at various stages of manufacture. The method 300 will be described with reference to the system 100 of FIG. 1 and the testing architecture 200 of FIG. 2.

In step 302, parametric performance measurements pertaining to the DUT 104 are obtained. For example, as discussed above with reference to the system 100, using the ATE 102, the parametric performance measurements may be ascertained. The method may further include a step where the parametric performance measurements are stored in a memory such as a memory of the computer 106. It should again be noted that the exemplary embodiments of the present invention may obtain parametric performance measurements from more than one DUT if the testing system is designed to test multiple DUTs concurrently.

In step 304, the parametric performance measurements are compared with the models. It should be noted that the method 300 may include a further step where the different models may be selected. That is, the use of the three models (e.g., PM 202, DM 204, SM 206) is only exemplary and, as discussed above, the specifications defined in select models may be used. The UM 208 may receive the parametric performance measurements. Depending on which models the manufacturer has selected or using all the models for determination of compliance, the UM 208 compares the measurements between the models. In step 306, the differences are determined from the comparison. That is, the UM 208 extrapolates the different results relating to compliance to the specifications of the models. For example, the UM 208 may determine that the frequency offset of the DUT 104 is non-compliant with the frequency offset specification included in the PM 202.

In step 308, a determination is made whether the differences are beyond an acceptable limit for a particular parametric performance measurement. As discussed above, the UM 208, each individual model, or a combination thereof may include the database with the acceptable limits for each parametric performance measurement. If all parametric performance measurements obtained from the DUT 104 comply with the specification defined in the models (e.g., all measurements are within the acceptable limits), then the method continues to step 322 where the current configuration of the DUT 104 on the production process used to manufacture the device is satisfactory.

If the step 308 determines that at least one parametric performance measurement is non-compliant with any specification of the models, then the method 300 continues to step 310. At step 310, a determination is made whether to alter the production process according to the PM 202 or the design of the DUT 104 according to the SM 204. However, it should be noted that, as discussed above, the exemplary embodiments of the present invention may either alter a model or alter the DUT. Thus, the use of altering the production process for the DUT 104 in the method 300 is only exemplary and the step 310 may be to alter a model (e.g., when the DUT 104 is designed with the highest capabilities). Furthermore, the use of the PM 202 is only exemplary and the step 310 may determine to alter the DUT 104 according to the specification defined in the DM 204 and/or the SM 206.

If the DUT 104 is determined to be altered according to the PM 202, the method 300 continues to step 312 where the appropriate alteration is determined. For example, if the frequency offset parametric performance measurement is non-compliant, the UM 208 may output a result that alters a component(s) of the DUT 104 that resolves the non-compliance. The UM 208 may include configuration data for the DUT 104 and may include an intelligence protocol to perform this determination. It should be noted that the use of the UM 208 is only exemplary and other components may be used to determine the appropriate alteration. For example, the respective model, the processor of the computer 106, etc. may perform the necessary algorithms.

Once a solution to the non-compliance is resolved in step 312 by complying with the PM 202, the proffered alteration is further tested with the DM 204 and/or the SM 206 in step 314. That is, step 314 determines if the output of step 312 conflicts with the DM 204 and/or the SM 206 creating another non-compliance issue. If no non-compliance issues arise, the method returns to step 302.

If the DUT 104 is determined to not be altered according to the PM 202 but to the DM 204 and/or the SM 206, the method 300 continues to step 316 where the appropriate alteration is determined. For example, similar to finding a solution compliant to the PM 202 (e.g., steps 312-314), if the frequency offset parametric performance measurement is non-compliant, the UM 208 may output a result that alters a component(s) of the DUT 104 that resolves the non-compliance. The UM 208 may include configuration data for the DUT 104 and may include an intelligence protocol to perform this determination. It should again be noted that the use of the UM 208 is only exemplary and other components may be used to determine the appropriate alteration.

Once a solution to the non-compliance is resolved in step 316 by complying with the DM 204 and/or the SM 206, the proffered alteration is further tested with the PM 202 in step 318. That is, step 318 determines if the output of step 316 conflicts with the PM 202 creating another non-compliance issue. If no non-compliance issues arise, the method returns to step 302.

If either step 314 or step 318 determines that the proffered alteration affects the other model(s), then the method 300 continues to step 320. In step 320, the UM 208 (or the respective models) may proffer other resolutions. These other resolutions may be, for example, (i) to not optimally resolve one issue, but not create other issues, (ii) alter other compliant parametric performance measurements so no other issues arise, (iii) alter the model with which the conflict exists, etc. These other resolutions may be displayed on an output device such as a monitor connected to the computer 106.

In a specific example of the above method, it may be determined that the UM 208 detects that measurements for a final test on a device is compliant with the SM 208 but not with the DM 204 (i.e., the determination of step 308 indicates non-compliance). This may occur if, for example, the device manufacturers used a more stringent requirement on a specific electrical parameter of the device with the intention of using it as a selling value against competitors. That is, the device may be non-compliant with the DM 204 but compliant with the SM 206 due to the laxer electrical parameter requirements. A decision may be made to simply mark the device as failing to satisfy the models. The UM 208 may also determine that keeping the stringent requirement by the DM 204 may have a significant effect on the yield because the PM 202 shows that physical manufacturing related to that parameter is very difficult. As a result, the manufacturer may change the DM 204 to use a model that provides a value for the electrical specification that is closer to the values of the SM 206 (i.e., product of step 320). Thus, manufacturer yield may increase but a loss in the competitive factor occurs.

It should be noted that the method 300 may include additional steps for other scenarios. For example, a determining step may be included for situations where no resolution may be found to resolve the non-compliance of either meeting the specification of the PM 202 or the DM 204 and/or the SM 206. The determining step may occur after step 312 and step 316, respectively. If the determining step finds that no resolution exists, then a message may be displayed on the output device such as a monitor connected to the computer 106. In another example, the parametric performance measurements, proffered alterations, and/or results of determinations may be displayed on the output device.

Those skilled in the art will understand that the present invention may be applied to components of electronic devices as well. That is, the use of a finalized electronic device (i.e., complete manufacture) is only exemplary. For example, a finalized component of the electronic device may be the “DUT” where various constituent parts are the “components.” Thus, applying the system and method described above, the configuration of components may also be tested.

Those skilled in the art will also understand that the above described exemplary embodiments may be implemented in any number of manners, including, as a separate software module, as a combination of hardware and software, etc. For example, the testing architecture 200 may be a program containing lines of code that, when compiled, may be executed on a processor.

The present invention provides results to be gathered during a production phase. The parametric performance measurements (i.e., results) may be used to verify the validity of the DM 204 and/or the SM 206. The parametric performance measurements may also be used to verify the current configurations of the DUT 104, thereby allowing the manufacturer to ascertain the proper changes necessary on the DUT 104. Through the UM 208 keeping track of differences between the PM 202 with the DM 204 and/or the SM 206, a manufacturer may track when there is such a difference between the PM 202 and the DM 204 and/or the SM 206. This may give rise, for example, to a trigger that indicates when a revision is necessary to either the DM 204 and/or the SM 206 or to switch to a characterization test for the DUT 104.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a first testing model including a first plurality of parameters and acceptable limits for the first plurality of parameters;
receiving a second testing model including a second plurality of parameters and acceptable limits for the second plurality of parameters;
receiving a first value for a first parameter from the first plurality of parameters, the first parameter at least partially affecting a second parameter from the second plurality of parameters;
determining a second value for the second parameter based on the first value;
determining if the first value is within the acceptable limits for the first parameter;
determining if the second value is within the acceptable limits for the second parameter; and
providing an indication when at least one of the first and second values is outside the acceptable limits for a corresponding one of the first and second parameters.

2. The method of claim 1, wherein the first and second parameters pertain to a performance metric of a device.

3. The method of claim 1, further comprising:
when the first value is outside the acceptable limits for the first parameter, proffering a first solution so that the first value adjusts to be within the acceptable limits for the first parameter.

4. The method of claim 3, further comprising:
determining a resulting second value based on the first value adjusted by the first solution.

5. The method of claim 4, further comprising:
determining if the resulting second value is within the acceptable limits for the second parameter.

6. The method of claim 5, further comprising:
providing a second solution so that the first and second values are within the acceptable limits for the corresponding one of the first and second parameters.

7. The method of claim 6, wherein the second solution is one of altering a component of a device and altering at least one of the models.

8. The method of claim 1, wherein the first test model is a production model specifying parameters during a production phase.

9. The method of claim 1, wherein the second test model is one of a device model specifying parameters for a finished device and a standard model specifying parameters defined by an industry standard.

10. The method of claim 1, wherein the first and second parameters are identical.

11. The method of claim 1, wherein the first and second values are identical.

12. A system, comprising:
a memory storing a first testing model including a first plurality of parameters and acceptable limits for the first plurality of parameters and a second testing model including a second plurality of parameters and acceptable limits for the second plurality of parameters; and
a processor receiving a first value for a first parameter from the first plurality of parameters, the first parameter at least partially affecting a second parameter from the second plurality of parameters, the processor determining a second value for the second parameter based on the first value, the processor determining if the first value is within the acceptable limits for the first parameter and determining if the second value is within the acceptable limits for the second parameter, the processor outputting an indication when at least one of the first and second values is outside the acceptable limits for the corresponding one of the first and second parameters.

13. The system of claim 11, wherein the at least one measurement pertains to a performance parameter of the device.

14. The system of claim 11, wherein the processor proffers a first solution so that the first value adjusts to be within the acceptable limits for the first parameter when the first value is outside the acceptable limits for the first parameter.

15. The system of claim 14, wherein the processor determines a resulting second value based on the first value adjusted by the first solution.

16. The system of claim 15, wherein the processor determines if the resulting second value is within the acceptable limits for the second parameter.

17. The system of claim 16, wherein the processor provides a second solution so that the first and second values are within the acceptable limits for the corresponding one of the first and second parameters.

18. The system of claim 12, wherein the first test model is a production model specifying parameters during a production phase.

19. The system of claim 12, wherein the second test model is one of a device model specifying parameters for a finished device and a standard model specifying parameters defined by an industry standard.

20. The system of claim 12, wherein the first and second parameters are identical.

21. The system of claim 12, wherein the first and second values are identical.

22. A computer readable storage medium including a set of instructions executable by a processor, the set of instructions operable to:
receive a first testing model including a first plurality of parameters and acceptable limits for the first plurality of parameters;
receive a second testing model including a second plurality of parameters and acceptable limits for the second plurality of parameters;
receive a first value for a first parameter from the first plurality of parameters, the first parameter at least partially affecting a second parameter from the second plurality of parameters;
determine a second value for the second parameter based on the first value;
determine if the first value is within the acceptable limits for the first parameter;
determine if the second value is within the acceptable limits for the second parameter; and
provide an indication when at least one of the first and second values is outside the acceptable limits for a corresponding one of the first and second parameters.
